(19) United States
(12) Patent Application Publication
(10) Pub. No.: US 2008/0022210 A1
(43) Pub. Date: Jan. 24, 2008

(54) Wedding Ceremony Information Distribution System

(76) Inventors: Tamihiko Izumino, Aichi (JP); Akira Ito, Aichi (JP); Hiroshi Nishigaki, Aichi (JP)

Correspondence Address: LOWE HAUPTMAN HAM & BERNER, LLP, 1700 DIAGONAL ROAD, SUITE 300, ALEXANDRIA, VA, 22314, US

(21) Appl. No.: 10/583,142

(22) PCT Filed: Dec. 6, 2004
(86) PCT No.: PCT/JP04/18142

§ 371 Date: Mar. 30, 2007

(30) Foreign Application Priority Data
Dec. 18, 2003 (JP) 2003-421696

(51) Int. Cl. G06F 3/00

(52) U.S. Cl. 715/731

(57) ABSTRACT

There is provided a wedding ceremony information distribution system for playing photographs taken in a wedding ceremony and names of participants, in a wedding reception hall. The system includes: a camera for imaging the wedding ceremony; a video image projection device for playing a video image edited/processed according to the image picked up; a computer terminal arranged in the wedding reception hall for transmitting the picked-up image data to an edition/distribution center so as to create moving picture data edited/processed by adding names of the participants in the wedding reception, illustrations, and animation, again receiving the data in the wedding reception hall so as to write video image onto a recording medium and reproducing/playing it by a video image projection device; and an edition/distribution center connected to a communication line for editing/processing the picked-up image data.

### TECHNICAL FIELD

The present invention relates to a wedding ceremony information distribution system for obtaining image data at a wedding hall, editing and processing the image data at a center connected to the hall via a communication network to produce video data, and transmitting the processed video data back to the wedding hall just prior to completion of the reception in order to play back a video at the wedding reception.

### BACKGROUND ART

The wedding industry has expanded rapidly in recent years, leading to a large number of patent applications on the subject of acquiring wedding-related information. For example, Patent Reference 1 discloses a “system for the simulation of a wedding ceremony” that displays data acquired via a network on a PC monitor to simulate the user trying on wedding clothes, such as a wedding dress. Patent Reference 2 discloses a “bridal support system” incorporating a spreadsheet program and the like listing various common wedding functions and accessories, the system enabling the user to efficiently determine a program and budget in a short amount of time and quickly determine which items to accept or reject. Patent Reference 3 discloses an “electronic bridal system” that provides an efficient and wide-ranging search of wedding halls over the Internet. Patent Reference 4 discloses a “marriage consultation system,” which as the name implies is a referral system for registering photographic portraits of men and women seeking marriage.

Patent Reference 5 discloses a “system for distributing video and voice of a wedding ceremony.” As shown in FIG. 18, this system includes a video camera 102 with a microphone for recording events at a wedding hall 101 as analog video, and a data transmitter 103 for converting the analog video to digital image data and transmitting the converted data to a distribution device 104. The distribution device 104 accumulates the image data in a format that can be transferred via the Internet. Friends and acquaintances of the wedding couple access the Internet from various terminals A 105, B 106, and the like and connect to the distribution device 104 using access IDs received previously from the wedding couple, enabling the friends and acquaintances to view events of the wedding ceremony distributed by the distribution device 104 on the same day of the wedding in a realistic format with audio and video.

Patent Reference 1: Japanese unexamined patent application publication No. 2003-76800

Patent Reference 2: Japanese unexamined patent application publication No. 2002-24430

Patent Reference 3: Japanese unexamined patent application publication No. 2001-344365

Patent Reference 4: Japanese unexamined patent application publication No. 2001-222583

Patent Reference 5: Japanese unexamined patent application publication No. 2002-351476

### DISCLOSURE OF THE INVENTION

### Problems to be Solved by the Invention

However, the systems disclosed in Patent Reference 1-4 described above, while wedding-related, address such pre-wedding issues as searching for a wedding hall and determining the scale of the wedding ceremony, including the budget and program, and do not address any methods of wedding notification on the day of the wedding.

The system disclosed in Patent Reference 5, on the other hand, is a system for distributing video footage of the wedding ceremony. However, this system merely accumulates video images taken of the ceremony on a distribution device and requires people wishing to view those images to search for the Web site on the Internet and view the images over the Internet. This system is unable to distribute the images at a specified time, as in a wedding notification distributed from the wedding couple by e-mail in bulk to friends and acquaintances upon completion of the wedding ceremony.

Therefore, it is an object of the present invention to provide a wedding ceremony information distribution system capable of transmitting image data of the wedding ceremony and reception taken at the wedding hall or the like to a center connected to the hall via a communication network, editing and processing the image data as a video to be played back at the reception hall, and distributing the video to the wedding hall.

It is another object of the present invention to provide a wedding ceremony information distribution system capable of issuing a bulk announcement following the wedding ceremony, quickly and efficiently, by distributing a wedding announcement having a message with attached wedding photos upon completion of the reception to pre-registered cellular telephones and the like.

It is another object of the present invention to provide a wedding ceremony information distribution system for receiving messages for the wedding couple via e-mail or the like from cellular telephones and the like and for including these messages accumulated on the day of the wedding on a Web site for the wedding couple upon completion of the reception.

### Means for Solving the Problems

The present invention according to Claim 1 resolves attains these objects with a wedding ceremony information distribution system for editing and processing image data taken at a wedding hall within a prescribed time at a center connected to a communication network and for transmitting the processed data in real-time to prescribed distribution destinations. The wedding ceremony information distribution system comprises one or a plurality of cameras disposed in a wedding hall for imaging a wedding ceremony and/or reception; a video projector and a computer terminal disposed in the wedding hall; and an editing/distribution center connected to the computer terminal via a communication network for editing, processing, and distributing image data taken at the wedding hall and transmitted by the computer terminal. The computer terminal comprises image data transmission means for transferring image data from the cameras into the computer terminal and transmitting the image data to the editing/distribution center; video data reception means for receiving video data edited and processed at the editing/distribution center based on the image data taken at the wedding hall; and video data writing means for writing video data received from the editing/distribution center onto a recording medium in order to play back the video data with the video projector. The editing/distribution center comprises image data reception means for receiving image data taken at the wedding hall and transferred to the computer terminal from the computer terminal; video data editing means for editing and processing the received image data by adding the names of people attending the reception, animation, and other prepared data for producing video data to be projected with the video projector; and video data transmission means for transmitting the edited and processed video data to the computer terminal.

Further, the image data transmission means of the computer terminal in Claim 2 transmits image data taken by the one or plurality of cameras disposed in the wedding hall to the editing/distribution center via the communication network as digital video data. The video data editing means at the editing/distribution center edits the digital video data transmitted from the computer terminal, including such images as the wedding ceremony performed at a church, shrine, or the like, the reception, speeches, and wedding accessories, and converts the data to streaming data. The video data transmission means distributes the streaming data via the communication network to prescribed distribution destinations pre-registered in a database.

The editing/distribution center in Claim 3 further comprises a server system comprising a mail server for collectively transmitting by e-mail a wedding announcement with an attached message and wedding photographs to a plurality of notification destinations within a prescribed time after completion of the wedding ceremony; a Web server for registering and editing e-mail addresses serving as distribution destinations in a Web browser of the computer terminal; an FTP server for managing file transfers with the computer terminal when transferring wedding-related data to be edited; and a database server for managing various data associated with the editing and distribution; and, functioning in conjunction with the server system, mail distribution list creation means for receiving a wedding plan for the wedding couple, a list of parties to be notified of a wedding announcement, an original e-mail to be distributed, and the like inputted into the computer terminal, for accepting reservations to receive the distributed e-mail and for creating a distribution list comprising a list of e-mail addresses for relatives, friends, and acquaintances to which the wedding announcement is to be distributed simultaneously on the day of the wedding; mail photographic data creation means for creating photographic data to be attached to an e-mail message by processing image data received from the computer terminal by the image data reception means; mail generation means for generating e-mail based on the mail photographic data and a registered e-mail original to be distributed in bulk to the addresses in the distribution list; and mail distribution means for distributing the e-mail generated by the mail generation means in bulk to the addresses in the distribution list so that the distribution is completed within a prescribed time following completion of the wedding ceremony.

The editing/distribution center Claim 4 further comprises message reception means for receiving messages addressed to the wedding couple by e-mail or via a Web page from a plurality of user terminals having made reservations to be on the mail distribution list and for saving the messages in a database; and Web page generation means for establishing a homepage for each member of the wedding couple, acquiring at least image data of the couple taken at the wedding hall with the cameras and various data included in messages from the plurality of user terminals from the database, and for generating Web pages and publishing these Web pages on a communication network.

The computer terminal in Claim 5 further comprises message card creation means for sharing various data with the editing/distribution center via a communication network, for generating a unique access code for each user on the e-mail distribution list, and for creating a message card for each user on the distribution list including the access code and an e-mail address and/or a Web page URL for recording a message for the wedding couple.

The editing/distribution center in Claim 6 further comprises member registration means for promoting member registration in a mail magazine distribution service as part of a wedding service by offering membership to users registered in the mail distribution list; mail magazine distribution/registration means for transmitting a Web page with information on subscribing to the mail magazine when the recipient of the e-mail accesses a Web page to solicit enrollment, and for receiving a reply e-mail with the user's e-mail address and registering membership information for the user in a database; and mail magazine distribution means for periodically distributing a mail magazine and coupons to the e-mail addresses registered in the database via the communication network.

The editing/distribution center in Claim 7 further comprises mobile distribution content service means for providing services to members registered by the member registration means via a cellular telephone, including various wallpaper image services for cellular telephones; on-demand application services providing a scheduler/calendar, an original clock, and the like; a ringtone service for providing various ringtones; fortune-telling services providing astrological predictions, compatibility readings, and the like; a Web camera service periodically distributing still images of an event from a live camera provided at the venue; and a cellular game service for games for portable devices.

### EFFECTS OF THE INVENTION

The wedding ceremony information distribution system according to the present invention can edit and process image data of wedding participants taken at the wedding venue, reception hall, or waiting lounge by adding pre-inputted guest information and prepared animation at the center, and can transmit the processed video back to the hall to be played at near real-time, thereby enhancing the impression given the participants at the hall.

The wedding ceremony information distribution system can also create e-mail including a message from the wedding couple, and attached photographs and the like taken at the wedding venue, and can distribute the e-mail as a wedding announcement to numerous recipients at once immediately upon completion of the wedding ceremony. The wedding ceremony information distribution system can also publish messages submitted to the wedding couple just prior to completion of the reception, photographs, and the like on a Web page for the wedding couple, so that the guests can receive the wedding announcement, which is usually sent after the married couple returns from their honeymoon, immediately after the wedding ceremony by referencing a Web site, thereby more effectively issuing a wedding notification than the conventional method and with a stronger impact when the impression of the wedding is still fresh in the minds of the guests.

### BRIEF DESCRIPTION OF THE DRAWINGS

FIG. 1 is a block diagram of a wedding ceremony information distribution system according to a preferred embodiment of the present invention.

FIG. 2 is a flowchart illustrating a process from imaging to playing back video in the wedding hall shown in FIG. 1.

FIG. 3 is a flowchart illustrating a mail distribution process.

FIG. 4 shows a registration form for requesting mail distribution.

FIG. 5 is a flowchart illustrating a process for playing back video at the wedding hall according to a second embodiment.

FIG. 6 is a flowchart illustrating a process for distributing video data according to the second embodiment.

FIG. 7 is an explanatory diagram on the provision of a fortune-telling message.

FIG. 8 is a flowchart illustrating a process for distributing the fortune-telling message of FIG. 7.

FIG. 9 is an explanatory diagram showing a Web site for the wedding couple.

FIG. 10 is a flowchart illustrating a process for generating the Web site for the wedding couple shown in FIG. 9.

FIG. 11 is a flowchart illustrating a process for distributing a mail magazine.

FIG. 12 is an explanatory diagram of an on-demand service in the content service.

FIG. 13 is an explanatory diagram of a ringtone service in the content service.

FIG. 14 is an explanatory diagram of an on-demand application in the content service.

FIG. 15 is an explanatory diagram of a portable on-line game service in the content service.

FIG. 16 is an explanatory diagram of a fortune-telling corner in the content service.

FIG. 17 is an explanatory diagram of a Web camera in the content service.

FIG. 18 is a block diagram of a conventional system for distributing audio and video of a wedding ceremony.

### DESCRIPTION OF THE REFERENCE NUMERALS

1 editing/distribution center

2 wedding hall (wedding venue/reception hall)

3 user terminal (cellular telephone)

4 communication network

5 Web server

6 mail server

7 FTP server

8 database server

9 mail distribution list creation means

10 mail photographic data creation means

11 mail generation means

12 mail distribution means

13 message reception means

14 Web page generation means

15 remote control means (server)

16 image data reception means

17 video data editing means

18 video data transmission means

19 mail magazine distribution/registration means

20 mail magazine distribution means

21 mobile content service distribution means

22 member registration means

23 database

24 in-hall imaging means

25 in-hall playing means

26 PC (personal computer)

27 image data transmission means

28 video data reception means

29 video data writing means

30 guest data inputting means

31 mail distribution reservation means

32 message card creation means

33 remote control means (client)

40 bride and groom

41 reservation entry window

42 e-mail address list

43 wedding photos

44 bulk distribution mail

45 work status list window

46 work status monitoring/e-mail distribution window

47 mail magazine

48 coupons

### BEST MODE FOR CARRYING OUT THE INVENTION

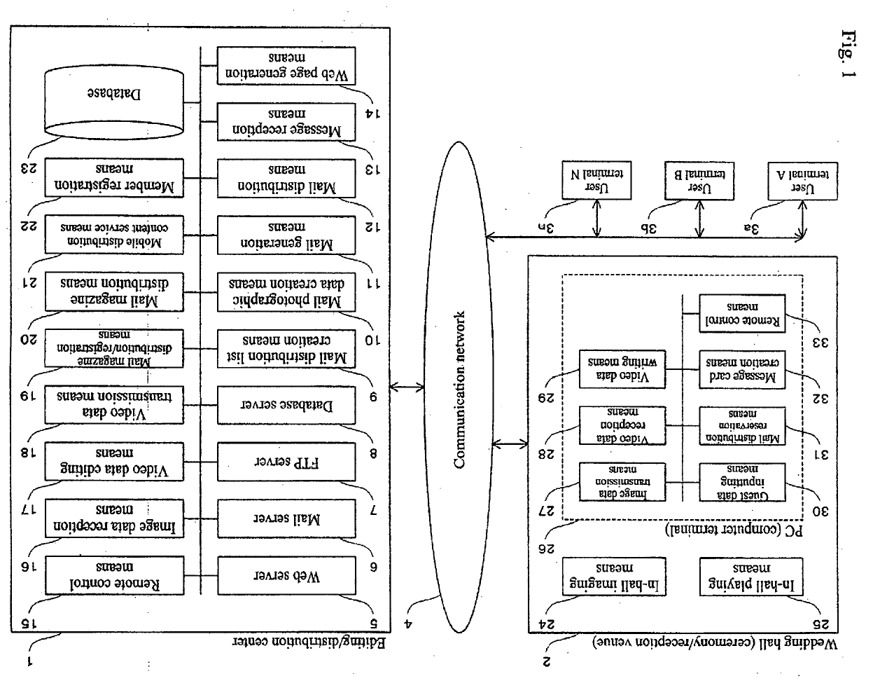

Next, the present invention will be described while referring to the accompanying drawings. FIG. 1 is a block diagram of a wedding ceremony information distribution system according to a preferred embodiment. As shown in FIG. 1, the system includes an editing/distribution center 1 and a wedding hall 2. The editing/distribution center 1 manages a server system including a Web server, mail server, and the like and controls overall operations for processing image data and the like received from wedding venues.

The wedding hall 2 transmits image data taken of the wedding venue and reception hall with cameras to the editing/distribution center 1 via a PC (computer terminal) 26 connected to a communication network 4, receives video data edited and processed at the editing/distribution center 1, and plays the video data in the reception hall. The system also includes a plurality of user terminals 3a-3n configured primarily of cellular telephones that function as destinations for distributed e-mail or streaming data; the communication network 4 configured of the Internet, a cellular telephone network, or the like.

The editing/distribution center 1 is provided with a Web server 5 for launching a homepage, producing Web pages, and controlling communications therewith; a mail server 6 for managing the sending and receiving of e-mail; an FTP server 7 for managing file transfers; and a database server 8 for managing a database that accumulates and stores various data related to the editing and distribution of wedding information.

The editing/distribution center 1 is also provided with a mail distribution list creation means 9 for sorting data related to mail distribution destinations by wedding hall and by mailing list group that is received from the PC 26, entering the data in a database, and creating a mailing list; a mail photographic data creation means 10 for producing photos for e-mail by editing and processing image data received from the PC 26; a mail generation means 11 for generating a bulk e-mail after editing mail data including photographic data and the title and message of the e-mail; and a mail distribution means 12 for sending the same e-mail simultaneously to a plurality of addresses registered in a group.

The editing/distribution center 1 is also provided with a message reception means 13 for receiving and storing in a database 23 messages for the wedding couple transmitted from guests at the wedding reception and the like to the address of the editing/distribution center 1 by a mail transmission function of a cellular telephone or the like; and a Web page generation means 14 for automatically generating in cooperation with the database server 8 and according to a server side program (not shown) on the Web server 5 a Web page for each member of the wedding couple that includes a message submitted by the wedding couple, photos and video taken at the wedding venue, and the like, and for publishing the Web pages on the Internet via the Web server 5.

The editing/distribution center 1 is also provided with remote control means 15 that works in conjunction with a remote control means 33 on the client side to implement automated and real-time operations on the editing/distribution center 1 side, enabling the PC 26 side to access prescribed means on the editing/distribution center 1 side directly; an image data reception means 16 for receiving image data taken at the wedding hall, downloaded into the PC 26, and transferred over the communication network 4; a video data editing means 17 for editing and processing guest data acquired previously from the PC 26 at the wedding hall by adding animation, illustrations, and the like to images taken at the wedding hall, and for converting digital video data received from the PC 26 to streaming data; and a video data transmission means 18 for transmitting the video data edited and processed by the video data editing means 17 back to the wedding hall 2 for playing back the video at the end of the reception.

The editing/distribution center 1 is also provided with a mail magazine distribution/registration means 19 for initiating a service targeted at users listed as destinations for mail distribution as part of the wedding services by registering in a database users accessing e-mail via the Internet and indicating a desire to receive distribution of a mail magazine; and a mail magazine distribution means 20 for distributing the mail magazine regularly or irregularly to the e-mail addresses of members registered in the database via the communication network, and for issuing special coupons giving discounts on products and services.

The editing/distribution center 1 is also provided with a mobile content service distribution means 21 for providing various services to registered members via cellular telephones, including wallpaper images, a scheduler, an original clock, ringtones, fortunes, a Web camera, and games; and a member registration means 22 for registering member information of users requesting the mail magazine or cellular telephone content in a database.

The editing/distribution center 1 is also provided with the database 23 for storing member data and the like from members registered in various services, including wedding-related services, using primarily wedding-related data as registrant information, in order to retain such users at mail distribution destinations and the like as repeat customers. The database 23 also stores a wedding photo, photos and videos of the wedding ceremony taken at the wedding venues, illustrations and animation used for editing and processing, and e-mail data including messages to the wedding couple.

The wedding hall 2 is provided with an in-hall imaging means 24 for saving images taken at the wedding venue and reception hall with a plurality of digital cameras and video cameras as digital image data in a storage device (not shown) of the PC 26; and a in-hall playing means 25 for playing back the video data received from the editing/distribution center 1 at the end of the reception using a video projector.

The PC 26 includes image data transmission means 27 for transmitting image data of the wedding venue and reception hall taken by the in-hall imaging means 24 and transferred to the PC 26 to the editing/distribution center 1 via the communication network 4; video data reception means 28 for receiving video data from the editing/distribution center 1 that the editing/distribution center 1 has edited, processed, and enhanced with guest information, illustrations, and animation; and video data writing means 29 for writing a video to be played back by the in-hall playing means 25 at the reception hall onto a recording medium (not shown), such as a DVD (digital versatile disc).

The PC 26 also includes guest data inputting means 30 for acquiring guest data from the wedding guests at the wedding venue or the reception hall inputted into the PC 26, saving the inputted data in a storage device (not shown) on the PC 26, and transmitting the data to the editing/distribution center 1 to be stored in a database on the editing/distribution center 1.

The PC 26 also includes mail distribution reservation means 31 for contracting with the wedding couple to register e-mail distribution destinations by receiving detailed data including e-mail addresses from the wedding couple for distributing e-mail on the day of the wedding and for transmitting this data to the editing/distribution center 1 to be stored in the database 23 at the editing/distribution center 1.

The PC 26 also includes message card creation means 32 for assigning unique access codes generated on the editing/distribution center 1 or on the PC 26 side in conjunction with the editing/distribution center 1 to each user of the mail distribution destinations acquired from the wedding couple and for printing message cards including this access code, and an e-mail address and Web page URL (Uniform Resource Locator) at which the user can submit messages for the wedding couple. The message cards are either handed out to the wedding guests at the wedding venue or are mailed directly to the desired delivery address.

The PC 26 is also provided with the remote control means 33 that performs automated and real-time operations in conjunction with the remote control means 15 on the server side, allowing the editing/distribution center 1 direct access to prescribed means on the PC 26.

Here, the Web server 5, mail server 6, FTP server 7, database server 8, and means 9-22 at the editing/distribution center 1 and the means 27-33 in the PC 26 are implemented through hardware or prescribed programs provided in commercial personal computers and workstations. Descriptions of and structural drawings for the various components of the personal computers and work stations, including a CPU (central processing unit), a hard disk and other memory, DVDs and other storage media, devices for displaying images, text, and the like, a keyboard, mouse, and other inputting devices, and I/O devices for exchanging data with the communication network 4, as well as externally connected devices such as printers and speakers, have been omitted. A connection configuration for the LAN (local area network) and the like in the editing/distribution center 1, including terminals for system administrators, is also omitted.

### FIRST EMBODIMENT

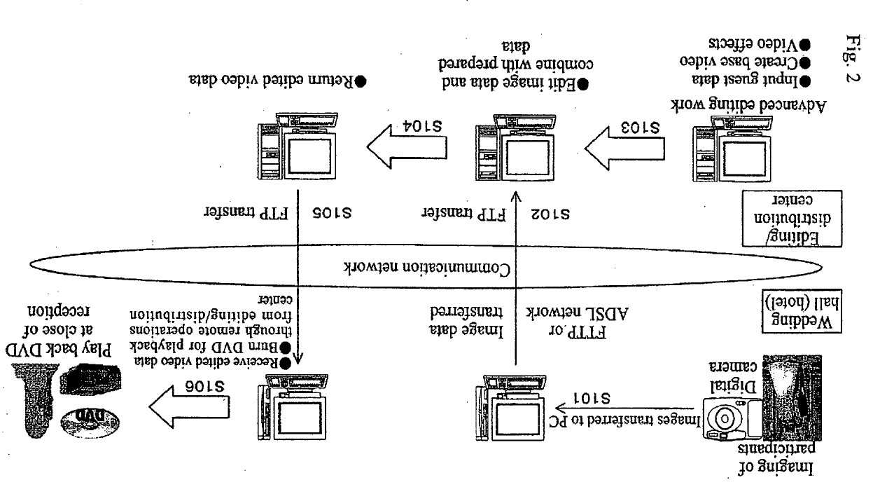

Next, the process performed by the wedding ceremony information distribution system from acquiring the images at the wedding venues to playing back video at the reception hall will be described with reference to FIG. 2.

Digital cameras of the in-hall imaging means 24 disposed at a plurality of locations acquire images of participants at the wedding and reception held at the wedding hall 2, such as at a hotel, and in a waiting lounge, lobby, and the like. The digital cameras are connected to the PC 26 by a USB (Universal Serial Bus) cable or the like and transfer images to the PC 26 (S101). The image data transmission means 27 transfers the image data taken at these venues to the editing/distribution center 1 according to FTP (File Transfer Protocol) via the communication network 4 (S102). Here, the communication network 4 is configured of a FTTH (Fiber to the Home) or a high-speed ADSL (Asymmetric Digital Subscriber Line) broadband network, for example.

Previously, guests of the wedding and reception have inputted their names and other data at the wedding hall 2 into the PC 26 using the guest data inputting means 30. This data has been transmitted to the editing/distribution center 1 and saved in the database.

Similarly, at the editing/distribution center 1 a base video and video effects to be combined with images taken at the wedding hall 2 are prepared as video data by reading illustrations and animations stored in advance in the database 23 via the database server 8 and adding various effects to the image data received from the wedding hall 2 via the PC 26. This video data is stored in the database 23 (S103). A common commercial editing software can be used for editing and processing various still images and video.

After the image data reception means 16 receives image data from the PC 26 through the FTP server 7, the video data editing means 17 at the editing/distribution center 1 edits the received image data and combines the base video and video effects created previously to create video data of the MPEG-2 (Moving Pictures Experts Group) format or the like in which the names of the guests are scrolled (S104). The edited composite video data is subsequently transferred back via the video data transmission means 18 and FTP server 7 to the PC 26 of the wedding hall 2 according to FTP transfer (S105).

The video data reception means 28 of the PC 26 receives the video data transferred from the editing/distribution center 1. Through remote control from the editing/distribution center 1 side, the video data writing means 29 is activated and controlled to burn the video data on a DVD for playback (S106).

The server side (or host side) remote control means 15 provided in the editing/distribution center 1 and the client side remote control means 33 incorporated in the PC 26 function together as a bi-directional remote control means for implementing remote control operations. A commercial software package for PC remote control can be used as the remote control software. Commercial software may also be used for writing (bunting) data to the DVD.

The DVD on which the video data writing means 29 has recorded a video is replayed on a video projector of the in-hall playing means 25 at the end of the reception, or the like.

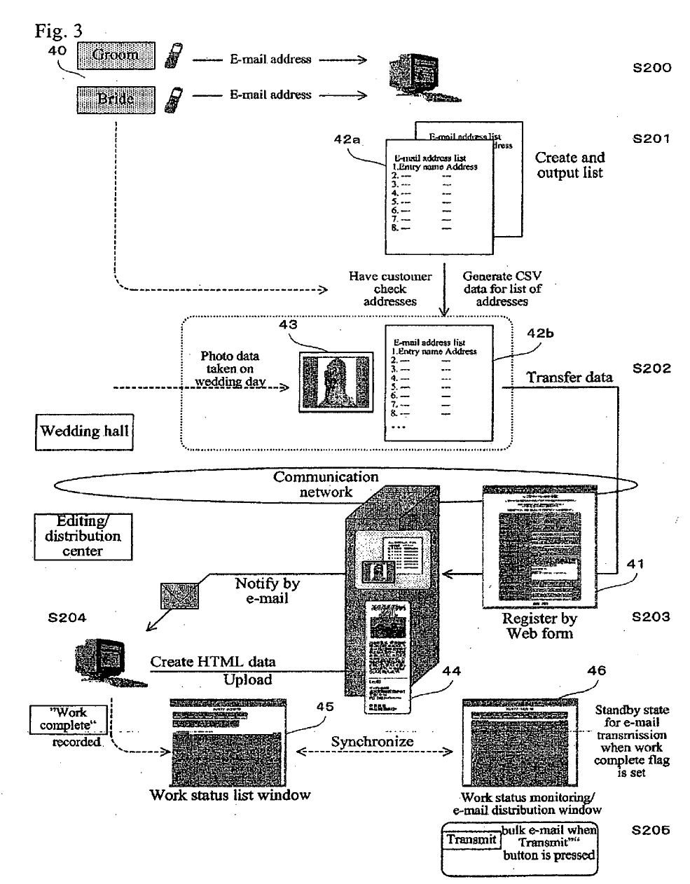

Next, a process for distributing wedding notifications by e-mail will be described with reference to FIG. 3.

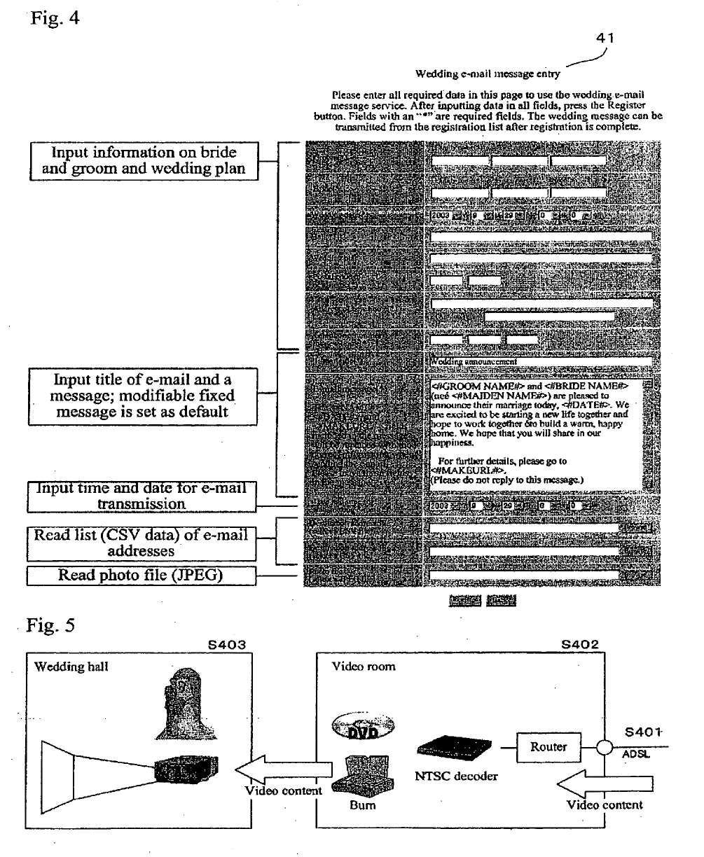

First, a bride and groom 40 make a reservation and enter a contract with the editing/distribution center 1 for the distribution of wedding announcements by e-mail. The method of making a reservation may be one of the following two methods, for example. The first method applies to the case in which the bride and groom 40 have already completed registration as service members of a wedding hall or the like registered in the editing/distribution center 1 and possess a user ID and password. In this case, the bride and groom 40 input the ID and password on a Web page. After authentication, a reservation entry window 41, such as that shown in FIG. 4, is displayed in the computer browser. In the appropriate spaces provided in the reservation entry window 41, the bride and groom 40 input the title of the e-mail, a message from the wedding couple, a list of e-mail addresses, and other required items. After clicking on the “Register” button to complete registration, the reservation procedure is completed.

However, for cases in which the bride and groom 40 or the like visit the wedding hall 2 to make reservations, the PC 26 at the wedding hall 2 can be connected to a cellular telephone of the bride and groom 40 with a USB cable or other proprietary cable, and the mail distribution reservation means 31 of the PC 26 (reception computer or the like at the wedding hall) can download mail distribution reservation details, such as an e-mail address list shown in FIG. 3, using functions for data editing, saving, and transferring between the PC and cellular telephone (step 200; hereinafter “step” will be abbreviated as “S”). The functions for data editing, saving, and transferring between the PC and cellular telephone can be implemented with a common commercial software.

After downloading the mail distribution reservation details, the mail distribution reservation means 31 generates an e-mail address list 42a based on the data acquired from the cellular telephone, prints out or displays the e-mail address list 42a on the monitor of the PC 26 for the bride and groom 40 to check and edit by deleting, modifying, or adding entries, and creates an e-mail address list 42b of only the desired addresses for e-mail distribution to be used for bulk distribution (S201). Alternatively, the data downloaded into the PC using the functions for data editing, saving, and transferring between the PC and cellular telephone can be first transmitted to the wedding hall 2 and displayed in a list on the Web page described above to be checked and edited. Further, as will be described later, a message card including a message registration destination configured of an e-mail address or a Web page URL, for example, and an access code is created for each user specified as a mail distribution destination at this time. These message cards can be given to the wedding couple at this time or can be mailed directly to each of the users, and congratulatory messages from guests at the wedding reception can be received via the Internet.

Next, on the day of the wedding, the image data transmission means 27 of the PC 26 transfers wedding photos 43 taken by a digital camera or the like at the wedding sites to the editing/distribution center 1 via the communication network 4 (S202). The image data reception means 16 of the editing/distribution center 1 receives a plurality of photographic data of the wedding photos 43 taken at the wedding sites (S203).

The mail distribution reservation means 31 transfers mail distribution destination data indicated in the e-mail address list 42b to the editing/distribution center 1 via the PC 26 and the communication network 4 (ADSL network, for example), which data is divided by wedding venue and by bulk distribution group and saved in the database, and also transmits the content of a message for a bulk distribution mail 44 of an e-mail acquired by the wedding couple when accepting mail distribution reservations. The data acquired by the mail distribution reservation means 31 may also be transmitted to the editing/distribution center 1 together with the photos taken on the day of the wedding (S203).

The database 23 functions to save the photographic data of the wedding photos 43, e-mail address list 42b, as well as a message from the wedding couple and congratulatory messages submitted by users in the reservation entry window 41 as content, and member information as registrant information.

The mail photographic data creation means 10 edits and processes the photographic data of the wedding photos 43 of the wedding sites received by the image data reception means 16 to produced JPEG (Joint Photographic Experts Group) data or the like of a size appropriate for e-mail transmission. The database server 8 reads the photographic data of the wedding photos 43 processed by the mail photographic data creation means 10, the e-mail address list 42b, and messages in the reservation entry window 41 from the database 23, and the mail generation means 11 generates an illustrated bulk distribution mail 44 (here, the photos may include photos submitted in advance during reservations).

The mail generation means 11 is further provided with editing means allowing the message for the bulk distribution mail 44 to be edited via a Web page by a person in charge of mail distribution or a system administrator working on a terminal (not shown in FIG. 1). Once the e-mail message for bulk distribution is automatically generated with the photographic data of the wedding photos 43, e-mail address list 42b, and the message from the wedding couple included in the reservation entry window 41, the editing/distribution center 1 transmits an e-mail notification to the person in charge of mail distribution or system administrator. Upon receiving this notification, the person in charge of mail distribution or the system administrator accesses a Web page for editing the e-mail, edits the message in a Web browser (not-shown) on the PC 26, and enters and displays the work status in a work status list window 45 (S204). As shown in FIG. 3, the person in charge of mail distribution or the system administrator may use an editor or the like to directly generate an HTML (Hyper Text Markup Language) message and upload the message to the Web site.

By referencing the same field of the database, the mail distribution means 12 at the editing/distribution center 1 provides the completion status of the bulk distribution mail 44 in synchronization with the work status list window 45 as a work status monitoring/e-mail distribution window 46. When the person in charge of mail distribution or system administrator clicks on a “Transmit” button in a Web page displayed on the control terminal upon completion of the bulk distribution mail 44, the e-mail distribution means 12 transmits the bulk distribution mail 44 as a bulk e-mail to all addresses in the group registered as the destination via the mail server 6 so that the bulk distribution mail 44 is transmitted to each of the user terminals 3a-3n in the distribution destination group (S205).

### SECOND EMBODIMENT

Next, a wedding video distribution service according to a second embodiment will be described, wherein a wedding video is distributed based on video data taken by video cameras in place of the still images taken by digital cameras described above.

With the video distribution service, the in-hall imaging means 24 at the wedding hall 2 captures scenes at the wedding or reception with video cameras and transfers the captured data to the PC 26 as digital video data. The PC 26 transfers the digital video data to the editing/distribution center 1 via FTTH or ADSL broadband, for example. The image data reception means 16 at the editing/distribution center 1 receives the video data, and the video data editing means 17 edits and processes the data by adding various effects.

The video data transmission means 18 transfers the processed digital video data back to the wedding hall 2 via the FTTH or ADSL broadband network. At the wedding hall 2, the video data reception means 28 of the PC 26 receives the digital video data, and the video data writing means 29 records the data on a DVD, video cassette, or other recording medium in a video editing room. A video projector of the in-hall playing means 25, for example, is subsequently used to reproduce and play back the video images at the reception hall, for example.

As shown in a flowchart of the video data process in FIG. 5, video content generated at the editing/distribution center 1 by adding various effects to video data taken at the wedding hall 2 and compressing the resulting data according to the MPEG-2 format or the like is transferred to the PC 26 (not shown) provided in the editing room across an ADSL network (S401). The PC 26 receives the video content via a router, converts the content to a television signal with an NTSC decoder, and records the signal on a recording medium such as a DVD or a video cassette (S402). The recording medium is then played back with a projector at the reception hall or the like (S403). The recorded DVD or video tape may also be distributed to interested parties.

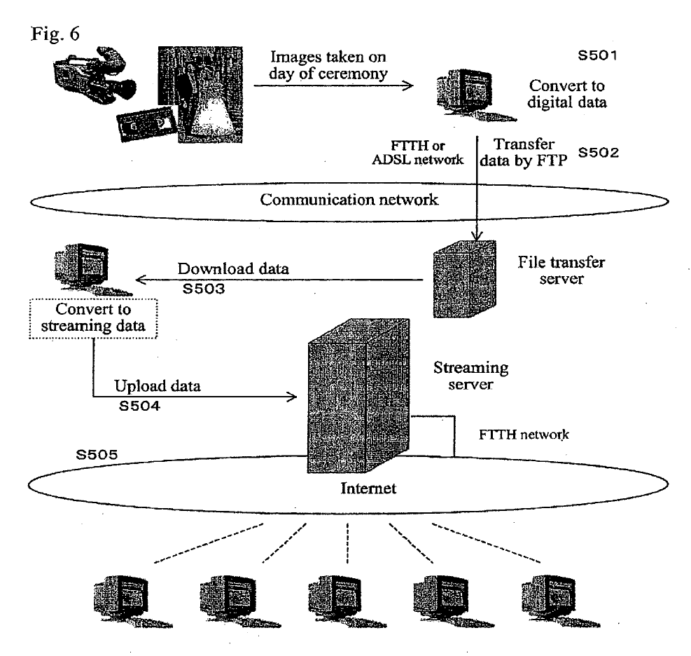

Next, a process for distributing streaming data will be described with reference to the flowchart in FIG. 6. As shown in the flowchart, video data taken by video cameras at the wedding venue is converted to digital data (S501) and transferred to the FTP server 7 via the FTTH or ADSL network (S502). A system administrator terminal (not shown in FIG. 1) connected to a LAN in the editing/distribution center 1 downloads the digital video data (S503) and converts the data to streaming data. The administrator terminal uploads the streaming data to a streaming server (not shown) in the editing/distribution center 1 (S504) for distributing the streaming data to the user terminals 3 on the communication network 4 over the FTTH network or the like (S505). Since the video data has been converted to a streaming signal in this case, the users of the user terminals 3 do not need to wait to receive all the data, but may display the video images as the streaming data is being received.

The video data may also be converted to an MPEG-4 format or the like for distribution to suitable portable devices. In this case, the video data can be distributed to the interested parties as an e-mail attachment.

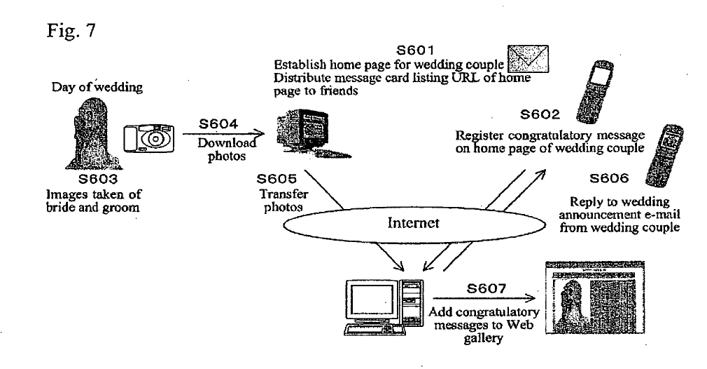

Next, a fraction of the first embodiment will be described again in detail with reference to FIGS. 7-10. In this process, guests at the wedding or reception and other users are invited to submit congratulatory messages to the wedding couple, and the submitted messages are posted together with photos and video taken at the wedding venue on a special homepage established for the wedding couple.

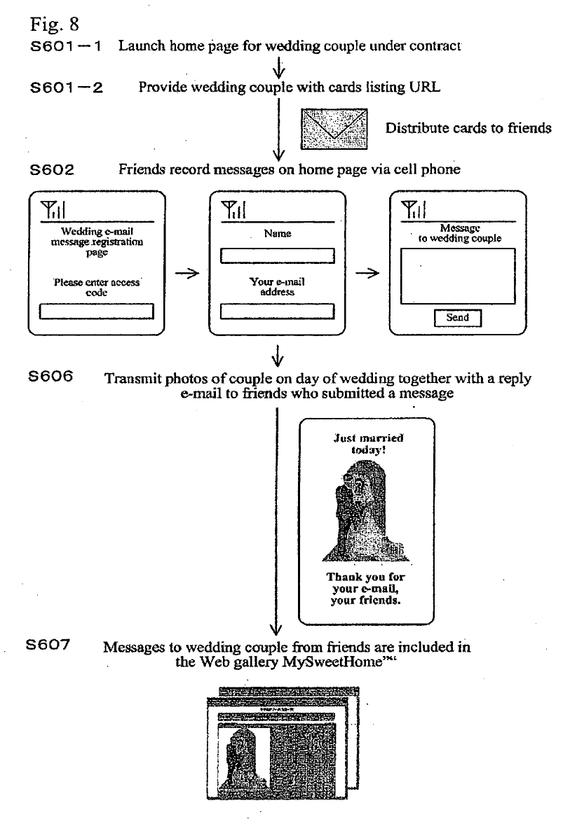

The process of generating congratulatory messages shown in FIG. 7 will be described according to the flowchart shown in FIG. 8. As described above, required data for the wedding, reception, and the like is acquired from the wedding couple at the wedding hall 2, and a special homepage is created based on the data registered at the editing/distribution center 1 (S601-1; in fact, only a URL and Web page form are created at this point).

At this time, a message card is created at the wedding hall 2 for each user in a list acquired from the wedding couple; for example, a list of guests invited to the reception. Each user is provided with a unique access code, and the message cards are printed out with this access code together with an e-mail address to which a congratulatory message can be transmitted and a URL to access for submitting a congratulatory message. The message cards are either given to the wedding couple or sent directly to the users by regular mail as desired (S601-2).

The access codes may be generated at the editing/distribution center 1 and received at the wedding hall 2 by accessing the editing/distribution center 1 with the PC 26, or may be generated on the PC 26 by a keyword issued from the editing/distribution center 1. In either case, the access codes on the PC 26 correspond to those at the editing/distribution center 1 so that users submitting messages can be identified. The access code functions as a user authorization code at the editing/distribution center 1.

In addition to e-mail messages received by the mail server 6, the editing/distribution center 1 may also employ Web mail for handling e-mail on a Web page or may be configured to collect message data from a Web page for registering congratulatory messages. Users may also directly access the homepage of the wedding couple and submit messages on a message board, blog, or the like.

Friends of the wedding couple and other users transmit congratulatory messages to e-mail addresses or a registration URL listed in the message card. Messages sent by cellular telephone (cell phone e-mail) can be sent right up to the end of the reception. An example of sending a message by cellular telephone is shown in FIG. 8. Here, the user accesses a URL listed in the message card to display a Web page for registering a congratulatory message transmitted from the Web server 5 of the editing/distribution center 1. The Web page prompts the user to input an access code. The user inputs the access code given in the message card to obtain authorization. Upon confirming that the user is a registered user, the Web server 5 transmits screens for prompting the user to input a name and e-mail address and for subsequently inputting a message for the wedding couple. After inputting a congratulatory message, the user clicks on the “Transmit” button to transmit the message to the editing/distribution center 1. The editing/distribution center 1 stores the message transmitted by the user in the database 23 as data registered for the homepage of the wedding couple (S602).

Further, image data including photos and video taken at the wedding venue (S603) is downloaded into the PC 26 (S604), transmitted to the editing/distribution center 1 (S605), and saved in the database 23. At the end of the wedding reception, the editing/distribution center 1 transmits an e-mail message with the wedding announcement described above to the e-mail addresses for user cellular telephones and the like (S606). These photos, videos, and congratulatory messages submitted by friends and the like are provided on the special web page created for the wedding couple together with a profile of the couple (S607). Specifically, the messages and image data are first saved in the database 23. Subsequently, the Web server 5 works in conjunction with the database server 8 according to a server side program, such as CGI (Common Gateway Interface), to extract required data according to SQL (Structured Query Language) or the like, and automatically generates a Web page that is published on the Internet.

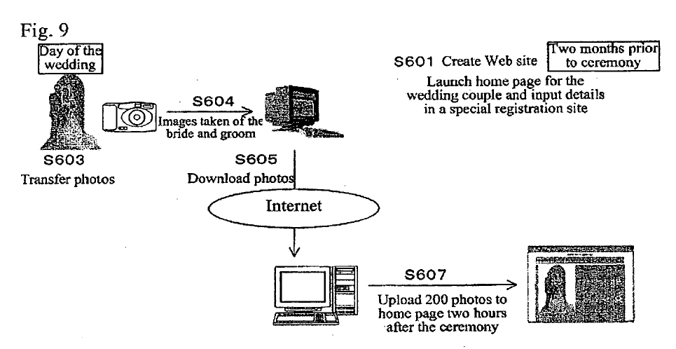

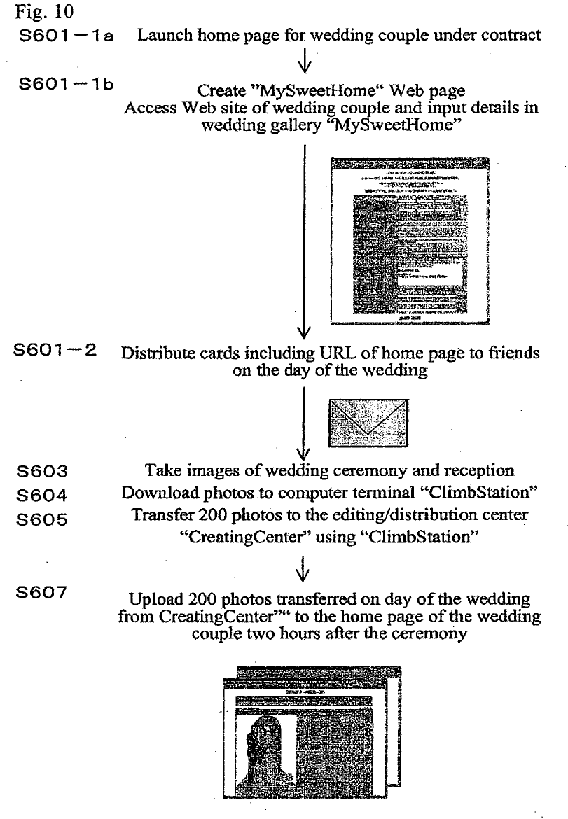

FIGS. 9 and 10 illustrate the process for creating a homepage for the wedding couple. After entering a contract at the Wedding site, as described in FIGS. 7 and 8, the editing/distribution center 1 launches a homepage for the wedding couple (referred to as “MySweetHome” in the drawings; S601-1a). From the PC 26, various data to be included in the Web page is inputted into various fields in a Web form, such as the reservation entry window 41 shown in FIG. 4, which data is subsequently registered in the database of the editing/distribution center 1 (S601-1b). The homepage is set up two months prior to the ceremony. When establishing the homepage, message cards with access codes are also created for inviting guests of the reception to submit congratulatory messages. As described above, the message cards may be given during the contract stage or may be handed out on the day of the wedding (S601-2). Congratulatory messages are submitted by cellular telephone and can be received until just prior to the end of the reception. The message cards passed out to the friends and the like of the wedding couple include a URL for the Web page of the wedding couple that includes a message from the wedding couple, congratulatory messages submitted by the users, photos, video, and a profile of the couple.

In the steps of S603-S607 described above with reference to FIGS. 7 and 8, photos and video taken of the bride and groom on the day of the ceremony at the wedding venue and reception hall (S603) are downloaded into the PC 26 (referred to as “ClimbStation” in the drawings) at the wedding hall 2 and are transferred to the editing/distribution center 1 (referred to as “CreatingCenter” in the drawings; S605). The transferred photos (200 in total) and video data are placed in the homepage of the wedding couple together with the submitted congratulatory messages within two hours after the wedding reception (S607).

Next, a wedding membership system will be described. This system provides various services aimed at attracting potential users and retaining repeat users of the wedding notification service by targeting distribution destinations of the bulk distribution mail 44 and users that access the wedding service Web site and the like at a wedding hall registered in the editing/distribution center 1.

As shown in FIG. 1, a mail magazine distribution system is configured of the mail magazine distribution/registration means 19 and the mail magazine distribution means 20 of the editing/distribution center 1. The mail magazine distribution/registration means 19 solicits registration from visitors accessing the Web site and users at distribution destinations of the bulk distribution mail 44. The mail magazine distribution means 20 transmits a mail magazine to addresses listed as distribution destinations for the main magazine as registration information for members registered in the database 23.

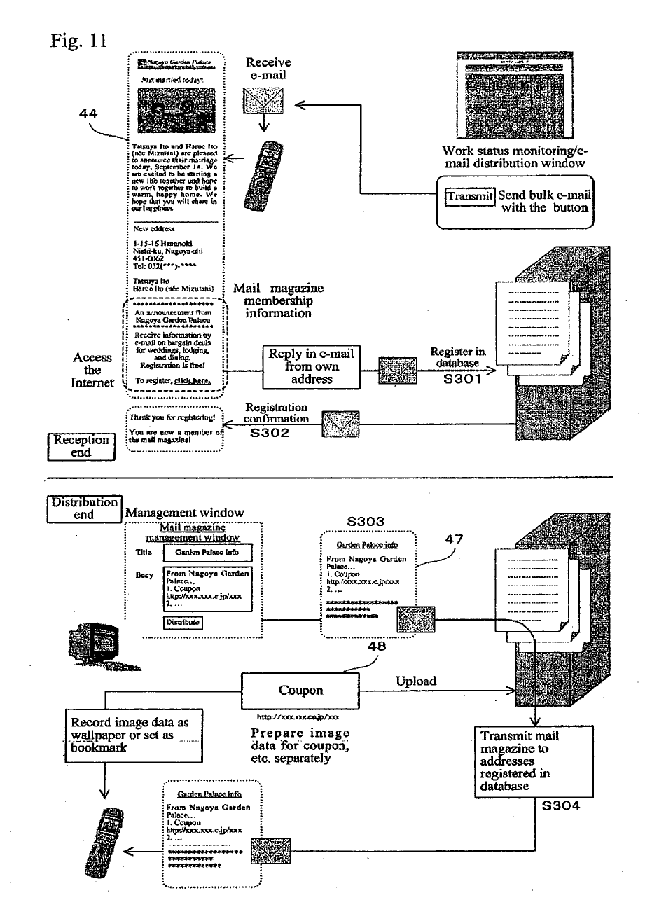

FIG. 11 is a flowchart illustrating a process for distributing the mail magazine. In some cases, the user receiving the bulk distribution mail 44 may access the Web site on the editing/distribution center 1 to acquire more detailed video of the wedding ceremony or information on the wedding couple or to acquire other service information. In such cases, the user sends an e-mail reply including the user's e-mail address, and the editing/distribution center 1 registers the user in the database 23 as a mail magazine member (S301). The editing/distribution center 1 sends a notification via the mail server 6 to the e-mail address of the user by e-mail confining registration (S302).

The mail magazine distribution means 20 creates a mail magazine 47 as indicated in a mail magazine management window with attached wedding information, lodging and dining information, coupons 48, and the like (S303) and transmits the mail magazine 47 in bulk to the e-mail addresses of members registered in the database 23 (S304). The user can set image data for the coupons 48 as wallpaper or an image file, or save bookmarks used to call up and display the coupons 48 on demand.

Next, various services offered to members will be described. The mobile content service distribution means 21 shown in FIG. 1 provides a service for distributing various content to cellular telephones 3, such as ringtones, wallpaper, and the like.

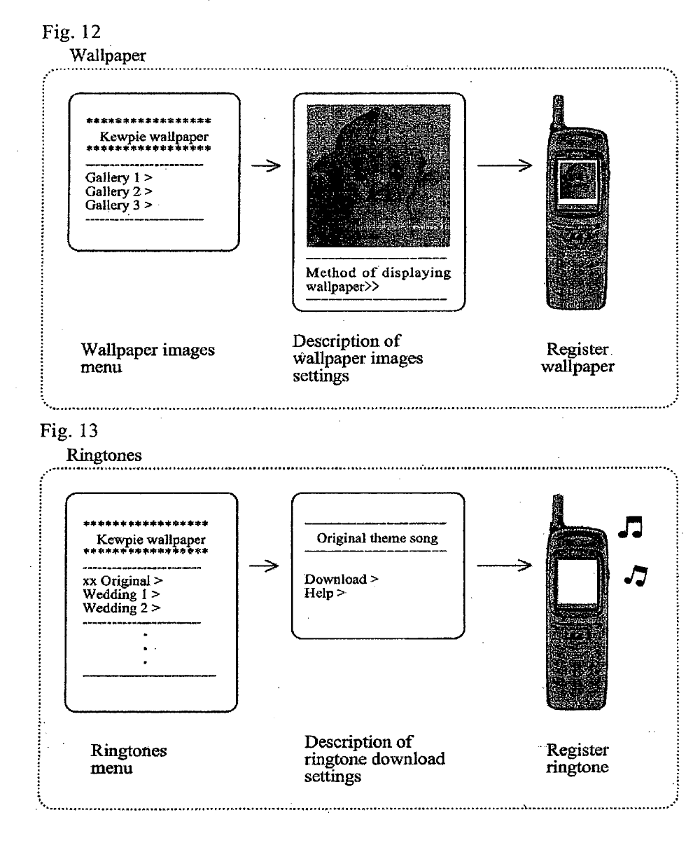

A service to distribute wallpaper will be described with reference to FIG. 12. A wallpaper Web site is one of various Web services offered by the editing/distribution center 1. When the user accesses the site, a menu page is displayed, enabling the user to select a desired image from a list (an image of Kewpie is displayed in the example of FIG. 12) to display the image. The user can record the new wallpaper image on the cellular telephone 3 according to a method for setting wallpaper. In addition to providing wallpaper of original characters in this way, the mobile content service distribution means 21 can provide a coupon service for recording coupons for complimentary services using the wallpaper, a service for providing a picture for wallpaper tailored to seasons, events, and the like, and, depending on the type of cellular telephone being used, a service for providing movies and animated images.

FIG. 13 illustrates a ringtone service. By accessing the ringtone menu page provided by the editing/distribution center 1, the user can select a desired ringtone, download ringtones to listen to, and record desired ringtones on the cellular telephone 3 as new ringtones. Examples of ringtone content include original songs played at a wedding ceremony, wedding songs, and the like.

Next, a description will be given for expanded services provided to cellular telephones that support Java (registered trademark) applications.

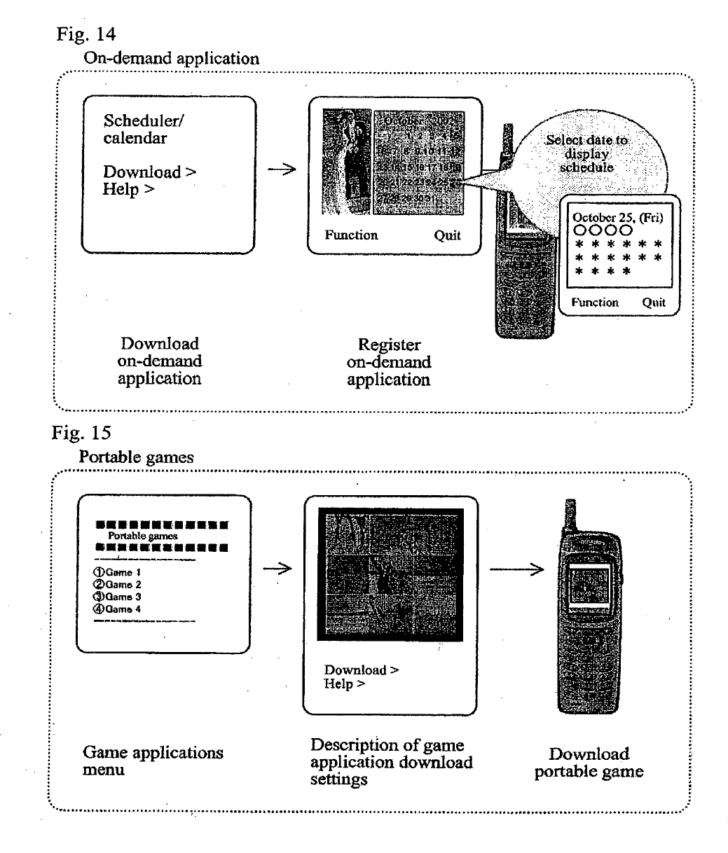

FIG. 14 illustrates an on-demand application. When using a cellular telephone that supports Java applications, the user can download not only content, but also a Java program for processing this content. Thereafter, the user need only download Java data from the editing/distribution center 1. Since the Java data can be displayed and processed on the cellular telephone 3, as shown in FIG. 14, the user can download Java content and programs in a standby screen according to the download method of the telephone. Therefore, the mobile content service distribution means 21 can provide various services for displaying a scheduler/calendar, the traditional Japanese rokuyō calendar, or original clock (even with analog display) when the user selects the time and date, for example.

Further, the user can change the images and characters used for the wallpaper and set images taken with the camera function on the cellular telephone 3 as wallpaper.

FIG. 15 is an explanatory diagram illustrating a portable game service. As shown in FIG. 15, the user downloads a Java game from a menu page to play the game on the user's cellular telephone. The user can play against a component through a group control function (not shown) provided on the editing/distribution center 1. Possible games include a puzzle with sliding pieces, Othello, solitaire, and other original games. Since only Java data is transferred to the cellular telephone 3 and the display process is performed on the cellular telephone 3 end, multiplayer games can be enjoyed at fast speeds. Other possibilities include quiz games that offer gifts to users capable of answering correctly.

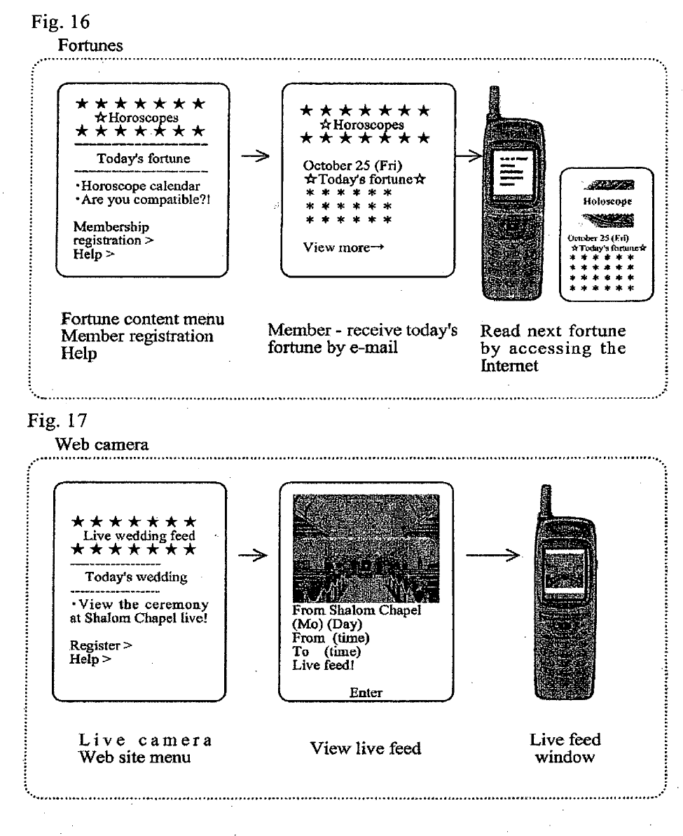

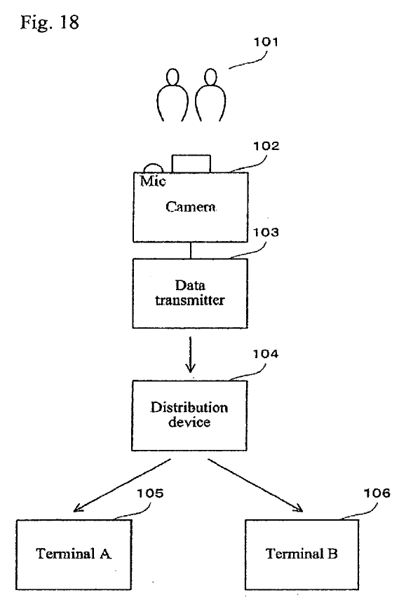

FIG. 16 is an explanatory diagram illustrating a fortune-telling corner. As shown in FIG. 16, when the user registers to join the fortune-telling corner from the menu page, the editing/distribution center 1 distributes e-mail to the user daily or weekly with such services as horoscopes, compatibility readings, blood-type analysis, psychological tests, Japanese omikuji fortunes, and the like. For example, it is possible to offer a service in which the user can read a continuation of fortunes from a previous time according to a Java application process performed on the server side (editing/distribution center 1) and the cellular telephone 3 side each time the user accesses the fortune-telling content. Another possible service could display a daily fortune using the calendar function when the user clicks on a date in the calendar.

FIG. 17 is an explanatory diagram illustrating a Web camera service. As shown in FIG. 17, the user can select a live relay feed from the menu page to display a window with a live feed. Hence, the mobile content service distribution means 21 can provide services for showing live still images of an event through a camera provided at a wedding hall, sports arena, or the like. The editing/distribution center 1 reloads the image taken by the live camera at the venue every minute, for example (the interval can be set arbitrarily), and distributes still image data to the user while keeping the volume of transmitted data low.

### INDUSTRIAL APPLICABILITY

As described above in the preferred embodiments, the wedding ceremony information distribution system according to the present invention can provide various services to members of a portable distribution content service and can take video images in addition to still images of a wedding. Accordingly, the user can view a movie of the wedding and, depending on the type of the user's terminal, can receive video data attached to e-mail distributed as a wedding notification.

Further, if the Web site of the system is accessed by a user who is listed as a distribution destination for the above e-mail or the like, the wedding ceremony information distribution system can register the user as a member of a wedding system to provide the user with a mail magazine subscription and various other services in order to bring in future customers for the wedding notification e-mail or to retain repeating customers.

It should be apparent that the content of the services described above is not limited to the examples given in the above description, and may include a variety of other services.

What is claimed is:

1. A wedding ceremony information distribution system for editing and processing image data taken at a wedding hall within a prescribed time at a center connected to a communication network and for transmitting the processed data in real-time to prescribed distribution destinations, the wedding ceremony information distribution system comprising:
one or a plurality of cameras disposed in a wedding hall for imaging a wedding ceremony and/or reception;
a video projector and a computer terminal disposed in the wedding hall; and
an editing/distribution center connected to the computer terminal via a communication network for editing, processing, and distributing image data taken at the wedding hall and transmitted by the computer terminal;
the computer terminal comprising:
image data transmission means for transferring image data from the cameras into the computer terminal and transmitting the image data to the editing/distribution center;
video data reception means for receiving video data edited and processed at the editing/distribution center based on the image data taken at the wedding hall; and
video data writing means for writing video data received from the editing/distribution center onto a recording medium in order to play back the video data with the video projector;
the editing/distribution center comprising:
image data reception means for receiving image data taken at the wedding hall and transferred to the computer terminal from the computer terminal;
video data editing means for editing and processing the received image data by adding the names of people attending the reception, animation, and other prepared data for producing video data to be projected with the video projector; and
video data transmission means for transmitting the edited and processed video data to the computer terminal.

2. A wedding ceremony information distribution system according to claim 1, wherein the image data transmission means of the computer terminal transmits image data taken by the one or plurality of cameras disposed in the wedding hall to the editing/distribution center via the communication network as digital video data;
the video data editing means at the editing/distribution center edits the digital video data transmitted from the computer terminal, including such images as the wedding ceremony performed at a church, shrine, or the like, the reception, speeches, and wedding accessories, and converts the data to streaming data; and
the video data transmission means distributes the streaming data via the communication network to prescribed distribution destinations pre-registered in a database.

3. A wedding ceremony information distribution system according to claim 1, wherein the editing/distribution center further comprises a server system comprising:
a mail server for collectively transmitting by e-mail a wedding announcement with an attached message and wedding photographs to a plurality of notification destinations within a prescribed time after completion of the wedding ceremony;
a Web server for registering and editing e-mail addresses serving as distribution destinations in a Web browser of the computer terminal;
an FTP server for managing file transfers with the computer terminal when transferring wedding-related data to be edited; and
a database server for managing various data associated with the editing and distribution; and,
functioning in conjunction with the server system,
mail distribution list creation means for receiving a wedding plan for the wedding couple, a list of parties to be notified of a wedding announcement, an original e-mail to be distributed, and the like inputted into the computer terminal, for accepting reservations to receive the distributed e-mail and for creating a distribution list comprising a list of e-mail addresses for relatives, friends, and acquaintances to which the wedding announcement is to be distributed simultaneously on the day of the wedding;
mail photographic data creation means for creating photographic data to be attached to an e-mail message by processing image data received from the computer terminal by the image data reception means;
mail generation means for generating e-mail based on the mail photographic data and a registered e-mail original to be distributed in bulk to the addresses in the distribution list; and
mail distribution means for distributing the e-mail generated by the mail generation means in bulk to the addresses in the distribution list so that the distribution is completed within a prescribed time following completion of the wedding ceremony.

4. A wedding ceremony information distribution system according to claim 3, wherein the editing/distribution center further comprises:
message reception means for receiving messages addressed to the wedding couple by e-mail or via a Web page from a plurality of user terminals having made reservations to be on the mail distribution list and for saving the messages in a database; and
Web page generation means for establishing a homepage for each member of the wedding couple, acquiring at least image data of the couple taken at the wedding hall with the cameras and various data included in messages from the plurality of user terminals from the database, and for generating Web pages and publishing these Web pages on a communication network.

5. A wedding ceremony information distribution system according to claim 4, wherein the computer terminal further comprises message card creation means for sharing various data with the editing/distribution center via a communication network, for generating a unique access code for each user on the e-mail distribution list, and for creating a message card for each user on the distribution list including the access code and an e-mail address and/or a Web page URL for recording a message for the wedding couple.

6. A wedding ceremony information distribution system according to claim 3, wherein the editing/distribution center further comprises:
member registration means for promoting member registration in a mail magazine distribution service as part of a wedding service by offering membership to users registered in the mail distribution list;
mail magazine distribution/registration means for transmitting a Web page with information on subscribing to the mail magazine when the recipient of the e-mail accesses a Web page to solicit enrollment, and for receiving a reply e-mail with the user's e-mail address and registering membership information for the user in a database; and
mail magazine distribution means for periodically distributing a mail magazine and coupons to the e-mail addresses registered in the database via the communication network.

7. A wedding ceremony information distribution system according to claim 6, wherein the editing/distribution center farther comprises mobile distribution content service means for providing services to members registered by the member registration means via a cellular telephone, including various wallpaper image services for cellular telephones; on-demand application services providing a scheduler/calendar, an original clock, and the like; a ringtone service for providing various ringtones; fortune-telling services providing astrological predictions, compatibility readings, and the like; a web cameras service periodically distributing still images of an event from a live camera provided at the venue; and a cellular game service for games for portable devices.
